(19) United States
(12) Patent Application Publication
(10) Pub. No.: US 2005/0253558 A1
(43) Pub. Date: Nov. 17, 2005

(54) Battery charger

(76) Inventors: Wei-Che Chiu, Gukeng Township (TW); Jing-Meng Liu, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/122,035

(22) Filed: May 5, 2005

(30) Foreign Application Priority Data
May 11, 2004 (TW) 093113209

(51) Int. Cl. H02J 7/00

(52) U.S. Cl. 320/134

(57) ABSTRACT

A battery charger comprises a power input to be connected to a power supply, a charge node to be connected with a battery, a N-channel or P-channel JFET coupled between the power input and the charge node, and a controller to monitor the voltage of the battery to control the JFET.

### FIELD OF THE INVENTION

The present invention is related generally to a battery charger and more particularly, to a battery charger with prevention of reverse current.

### BACKGROUND OF THE INVENTION

FIG. 1 shows a simplified diagram of a conventional battery charger 10. When a battery 12 is coupled to the battery charger 10, a controller 14 of the battery charger 10 senses the voltage of the battery 12 from its monitor input 142 and determines a signal on its control output 144 to switch a PMOS 16 coupled between a power supply VDD and the battery 12. When the PMOS 16 turns on, the battery 12 is charged by the power supply VDD, and when the PMOS 16 turns off, the battery 12 is stopped to be charged by the power supply VDD.

However, when power abnormal or abnormal operation occurred in the PMOS 16, a reverse current will be presented to flow through a body diode 18 that is induced by the body effect in the PMOS 16. Therefore, it requires an additional diode D1 coupled between the power supply VDD and the PMOS 16 to prevent the reverse current flowing from the battery 12 to the power supply VDD or to the controller 14.

FIG. 2 shows a simplified diagram of another conventional battery charger 20 that also comprises the controller 14, while a PNP Bipolar Junction Transistor (BJT) 22 is used as the switch coupled between the power supply VDD and the battery 12. Likewise, the controller 14 senses the voltage of the battery 12 from its monitor input 142 and determines the signal on its control output 144 to switch the BJT 22. When the BJT 22 turns on, the battery 12 is charged by the power supply VDD, and when the BJT 22 turns off, the battery 12 is stopped to be charged by the power supply VDD.

Though the BJT 22 in the battery charger 20 could prevent reverse current, the input impedance of the base of the BJT 22 is so small that high base current I_{b} is generated, and thereby high power loss is induced.

Therefore, it is desired a battery charger that prevents reverse current not by diode and does not has high power loss.

### SUMMARY OF THE INVENTION

One object of the present invention is to provide a battery charger that prevents reverse current not by diode and does not has high power loss.

According to the present invention, a battery charger comprises a Junction Field-Effect Transistor (JFET) coupled between a power input to be connected to a power supply and a charge node to be connected with a battery under charged, and the gate of the JFET is coupled to a controller. The controller is further coupled to the charge node to monitor the voltage of the battery and controls the JFET accordingly, so as to charge the battery or to stop charging the battery.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a conventional battery charger;

FIG. 2 shows another conventional battery charger;

FIG. 3 shows an embodiment according to the present invention; and

FIG. 4 shows another embodiment according to the present invention.

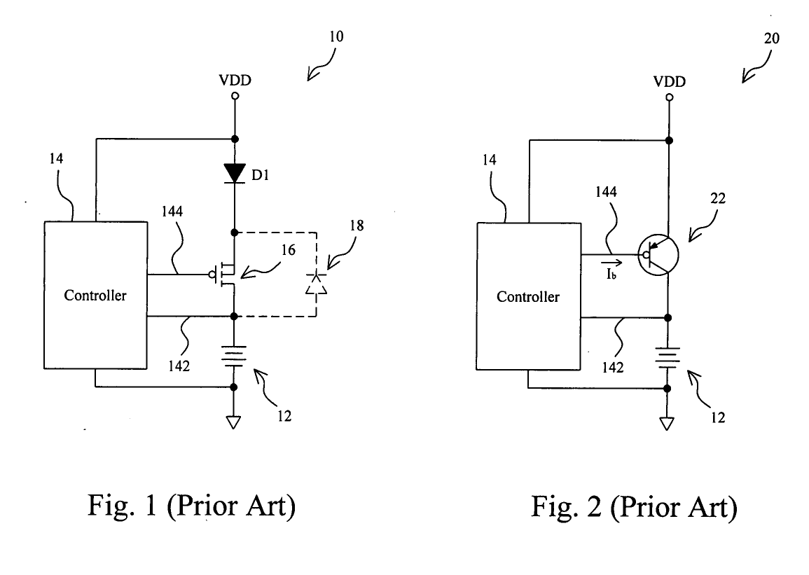

### DETAILED DESCRIPTION OF THE INVENTION

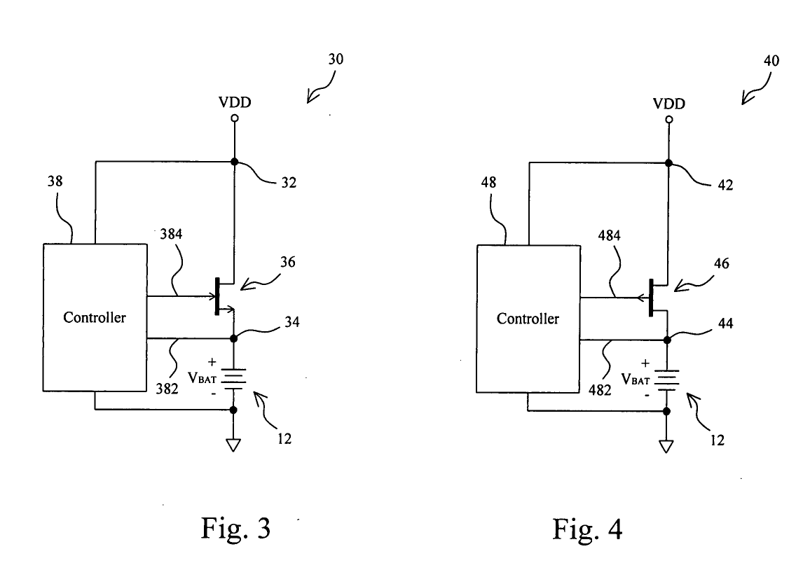

FIG. 3 shows an embodiment according to the present invention. A battery charger 30 comprises a power input 32 to be connected to a power supply, a charge node 34 to be connected with a battery under charged, an N-channel JFET 36 coupled between the power input 32 and the charge node 34, a controller 38 coupled to the power input 32, the charge node 34 and the gate of the JFET 36. As shown in FIG. 3, when the battery charger 30 is connected to a power supply VDD and is connected with a battery 12, the controller 34 senses the voltage VBAT of the battery 12 from its monitor input 382 and determines a signal on its control output 384 to control the JFET 36. When the JFET 36 turns on, the battery 12 is charged by the power supply VDD, and when the JFET 36 turns off, the battery 12 is stopped to be charged by the power supply VDD. By controlling the JFET 36 through its gate, the battery charger 30 charges or stops charging the battery 12. In addition to behave as a switch, the N-channel JFET 36 can act as a source follower output stage of voltage and current regulation, as an NMOS do.

FIG. 4 shows another embodiment according to the present invention. A battery charger 40 comprises a power input 42 to be connected to a power supply, a charge node 44 to be connected with a battery under charged, a P-channel JFET 46 coupled between the power input 42 and the charge node 44, a controller 48 coupled to the power input 42, the charge node 44 and the gate of the JFET 46. When the battery charger 40 is connected to a power supply VDD and is connected with a battery 12, the controller 44 senses the voltage VBAT of the battery 12 from its monitor input 482 and determines a signal on its control output 484 to control the JFET 46. When the JFET 46 turns on, the battery 12 is charged by the power supply VDD, and when the JFET 46 turns off, the battery 12 is stopped to be charged by the power supply VDD. By controlling the JFET 46 through its gate, the battery charger 40 charges or stops charging the battery 12. In addition to behave as a switch, the P-channel JFET 46 can act as a gain stage of voltage and current regulation, as a PMOS do.

Similarly to a MOS, a JFET has an input impedance approaching to unlimited value, and therefore the input current to its gate is zero, thereby inducing no power loss. Furthermore, no body diode is presented in the structure of a JFET, and therefore there is no need to insert an additional diode between the power supply and the JFET to prevent reverse current.

It is a prior art for the controller 38 and 48 to monitor the voltage V_{BAT} of the battery 12, and reader is referred to for example the battery charger proposed in U.S. Pat. No. 5,576,608 issued to Yeon, which uses filter, buffer, amplifier and sample and hold circuit to monitor the voltage of a battery under charged.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A battery charger comprising:
a power input for being connected to a power supply;
a charge node for being connected with a battery;
a JFET coupled between the power input and the charge node; and
a controller for monitoring a voltage of the battery to control the JFET.

2. The battery charger of claim 1, wherein the JFET is an N-channel JFET.

3. The battery charger of claim 1, wherein the JFET is a P-channel JFET.
